(19) United States
(12) Patent Application Publication
(10) Pub. No.: US 2013/0163234 A1
(43) Pub. Date: Jun. 27, 2013

(54) BLOCK LED LIGHT

(71) Applicants: Chuang Tzu Hsien, Luzhu Township (TW); Chyan Yu Chien, Luzhu Township (TW)

(72) Inventors: Chuang Tzu Hsien, Luzhu Township (TW); Chyan Yu Chien, Luzhu Township (TW)

(21) Appl. No.: 13/332,410

(22) Filed: Dec. 21, 2011

(51) Int. Cl. F21L 4/02; F21V 21/00

(52) U.S. Cl. 362/190; 362/249.02

(57) ABSTRACT

A block LED light comprises one first block case; one LED light module which is contained in the first block case; one first connecting portion which is designed at the surface of the first block case; one second connecting portion which is designed at another surface of the fist block case; in which the first connecting portion is corresponding to the second connecting portion, to make a second block LED light with the same architecture be able to assemble with the second connecting portion of the first block LED light by its first connecting portion.

### FIELD OF THE INVENTION

The present invention relates to a block LED (Light Emitting Diode) light, especially for the one that is able to assemble multiple block LED lights together as any shape; furthermore, the power connection port is able to be adopted with the LED light module, making end users be able to select different electrical power types of block LED lights by different demand purposes.

### BACKGROUND OF THE INVENTION

The traditional LED (Light Emitting Diode) light is implemented by case, LED light module, and lampshade. The LED light module is implemented in the case, and the lampshade is connected with the case and covers the LED light module. Because high power LED light would generate lots of heat and thermal during operating, which would increase the temperature and this high temperature would also affect the life time of LED light, therefore, such type of LED light also contains extra thermal module in the architecture, and this thermal module connects with the LED light to increase the thermal performance.

The shape of traditional LED light is decided by the case and lampshade, the shapes of case and lampshade are fixed and the sizes can not be changed. Some LED lights use external thermal modules, and these thermal modules are integrated by different shapes of heat sinks, which shapes are also fixed and can not be changed by user's demand. Therefore, a user needs to survey and choose the most suitable LED light from different shaped and different sized LED lights by actual environment and demand, this survey process always takes lots of time and even can not discover the most suitable LED light that can meat user's demand.

Further more, the electrical power of traditional LED light is also fixed without any modification, so the LED light that is able to commit shape and size requirements could be not able to meet the demand of electrical power, which increases the difficulty of purchasing suitable LED light. One more thing, once the layout design is changed, the original LED light might be not able to meet current requirement and need to survey and purchase a new LED light again.

On the other hand, no matter using a general LED light or high power LED light, these types of traditional LED lights all use single case architecture, and the LED light module and electrical power are both integrated in the same case, for example, in the mobile LED light case, it contains both the LED light module and containing space of batteries, to provide electrical power to LED light module by batteries; for fixed LED light, it integrates LED light module and electrical power connecting port in the same case, in which the electrical power connecting port connects with the LED light module, and also connects with the electrical power socket, to electrical connect LED light module with electrical power source via this electrical power line.

In the traditional LED light, it integrates the LED light module with electrical power portion in one single case, so the LED light module and electrical power portion are not able to be separated, users are not able to choose and swap different types of electrical power by different demands, for example, in some accident conditions such as electrical power off, users are not able to take off the fixed lamps which electrical connect with electrical power source to connect with batteries directly as emergency fluorescent lights, so users have to prepare several different types of lamps to meet different demands of purposes. Although some of the traditional LED lights also be able to provide dual types of electrical power sources to choose battery source or electrical power supply, but the space of battery container in the LED light case is not able to be removed when the power supplied by electrical power source; on the other hand, the power connection port or power cord that connects with electrical power source can not be removed when the power supplied by batteries, therefore the size of traditional LED light is little bit larger.

There are several disadvantages in the technologies of traditional technology:

1. For the traditional LED light, the shape of LED light is decided by case and lampshade, the shapes and sizes of case and lampshade can not be changed by users' demands.
2. For the traditional LED light, the power of LED light is also fixed, can not be changed by users' demands.
3. For the traditional LED light, the model spec of LED light is fixed, not easy to survey the most suitable LED light that is able to meet all demands completely.
4. For the traditional LED light, users are not able to change different types of electrical power sources by their requirements or demands;
5. For the traditional LED light, LED light just is suitable to use in one single environment, so end users have to prepare multiple lamps for different types to meet the demands of different requirements and purposes;
6. For the traditional LED light, although some of the LED lights are able to choose their power supply coming from battery or electrical power source, the battery containing space can not be removed during electrical power supplying; on the other hand, the electrical power cord or electrical power connection port can not be removed during battery supplying, therefore the space of LED light will be little larger.

Therefore, the way how to improve above disadvantages of traditional solutions to change the shape and electrical power of the LED light by user's requirement and demand, and to be able to connect with different types of electrical power sources is the major topic of the present invention.

### SUMMARY OF THE INVENTION

An objective of the present invention is to provide a new and advanced block LED light, which designs two corresponding connecting portions on the surfaces of case, for example, an embedded pillar and an embedded trough, a pair of magnetic, or a magnetic and corresponding components such as a piece of metal plate, to make a block LED light be able to integrate with another block LED light with same architecture via their corresponding connection portions, to meet user's requirement and demand for assembling any quantity and any total electrical power of block LED lights together as any shape or model as user's like. On the other hand, LED light module and electrical power portion are able to be designed in two different cases, these two different cases support corresponding connection portions on their surfaces to make the LED light module be able to electricalic connect to the power source after integrating these two cases; by this way, user is able to integrate LED lights with suitable electrical power source together by their real requirement and demand.

### BRIEF DESCRIPTION OF THE INVENTION

According to the present invention, the present invention provides a new and advanced block LED light, which contains the following components:

A first case;

A LED light module, which is designed in the first case;

A first connection portion, which is designed on the surface of the first case;

Ane second connection portion, which is designed on another surface of the first case;

In which, the first connection portion is corresponding to the second connection portion, making another second block LED light with the same architecture be able to connect with the second connection portion of the first block LED light by its first connection portion; and another third block LED light with the same architecture be able to connect with the second portion of the second block LED light by its first connection portion; this way would be able to assemble multiple block LED lights together.

In accordance with the block LED light, in which first connection portion contains at least one embedded pillar, and the second connection portion contains at least on embedded trough; the architecture of this embedded pillar has to be corresponding to this embedded trough; this block LED light connects with another block LED light's embedded trough (or embedded pillar) by its corresponding embedded pillar (or embedded trough).

In accordance with the block LED light, in which there is a first magnetic on the first connection portion, and there is a second magnetic on the second connection portion; this block LED light uses its first magnetic to connect with another block LED light's second magnetic, to integrate with this second block LED light.

In accordance with the block LED light, in which the electrical power port of the LED light module will extend to the first connection portion and the second connection portion, to make multiple block LED lights be able to electrical connect together by series or parallel after these multiple block LED lights integrating together.

In accordance with the block LED light, in which further contains one first conductive component, one second case, one electrical connection portion, one second conductive component, and one third connection portion; this first conductive component is designed on the surface of the first case, and electrical connects with the LED light modules; this electrical power connection portion is designed in the second case, and is designed to electrical connect with one electrical power source; this second conductive component and this third connection portion are designed on the surface of the second case, and this second conductive component is electrical connecting with the electrical power connection portion; the third connection portion on the second case and the first connection portion on the first case are corresponding, to make this first case and this second case be able to integrate together by the first connection portion of the first case and the third connection portion of the second case, and when the first connection portion of the first case integrates with the third connection portion of the second case, the first conductive component of the first case will electrical connect with the second conductive component of the second case, to make the LED light module electrical connect with power source.

In accordance with the block LED light, in which the first conductive component and the second conductive component are conductive plates.

In accordance with the block LED light, in which the electrical power source connection portion is an electrical power connection port; and the electrical power source is a grid.

In accordance with the block LED light, in which the second case contains one containing space, and the electrical power source is battery, which is contained in this contain space.

In accordance with the block LED light, in which the first connection portion of the first case contains at least one embedded pillar, and the third connection portion of the second case contains at least one embedded trough; this embedded pillar is corresponding to the embedded trough, and this first connection portion of the first case integrates with the third connection portion of the second case via embedding these embedded pillar and embedded trough.

In accordance with the block LED light, in which the first connection portion of the first case contains one first magnetic, and the third connection portion of the second case contains one second magnetic; this first connection portion of the first case integrates with the third connection portion of the second case via attracting this first magnetic and this second magnetic.

In accordance with the block LED light, in which the first connection portion of the first case contains one magnetic, and the third connection portion of the second case contains a piece of metal plate; this first connection portion of the first case integrates with the third connection portion of the second case via attracting this magnetic and this metal plate.

In accordance with the block LED light, in which the first connection portion of the first case contains one pieces of metal plate, and the third connection portion of the second case contains a magnetic; this first connection portion of the first case integrates with the third connection portion of the second case via attracting this magnetic and this metal plate.

The present invention may best be understood through the following description with reference to the accompanying drawings, in which:

### BRIEF DESCRIPTION OF THE DRAWINGS

FIG. 1 shows the system architecture diagram of the executing embodiment to the present invention of the block LED light using one single case.

FIG. 2 shows the system's bottom architecture diagram of the executing embodiment to the present invention of the block LED light using one single case.

FIG. 3 shows the assembling architecture diagram of the executing embodiment to the present invention of multiple block LED lights using one single case.

FIG. 4 shows the architecture diagram of the executing embodiment to the present invention of block LED light using grid power source.

FIG. 5 shows the architecture diagram of the executing embodiment to the present invention of block LED light using battery power source.

FIG. 6 shows the architecture diagram of the executing embodiment to the present invention of block LED light using chargeable battery power source.

FIG. 7 shows the architecture diagram of the executing embodiment to the present invention of assembling multiple LED lights.

### DETAILED DESCRIPTION OF THE PREFERRED EMBODIMENT

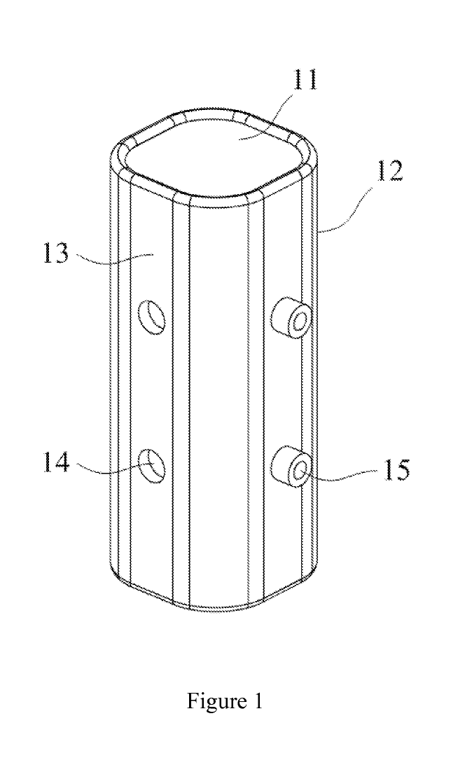

FIG. 1 shows the system architecture diagram of the executing embodiment to the present invention of the block LED light using one single case, in which contains lamp shade 11, block LED light 12, case 13, embedded pillar 14, and embedded trough 15. The block LED light 12 of the present invention is mainly implemented by lamp shade 11, LED light module, and case 13. This LED light module is designed in the case 13, lamp shade 11 connects with case 13, and covers LED light module in the space created by the connection of lamp shade 11 and case 13. Lamp shade 11 is produced by transparent material, therefore the light emitted by LED light module is able to transmit out through lamp shade 11. There is a pair of corresponding connection portions on the surface of case 13, these two corresponding connection portions can be implemented by at least one pair of corresponding embedded pillar 14 and embedded trough 15. Therefore, the embedded trough 14 (embedded pillar 15) of the block LED light 12 is able to integrate with another block LED light's embedded pillar (embedded trough) which is implemented with the same architecture, to connect these two block LED lights together. Based on the architecture design of embedded pillar 14 and embedded trough 15, multiple block LED lights 12 with the same architecture could be able to integrate together such as integrating blocks. Of course, corresponding connection portions on the surface of case 13 can also be implemented by two corresponding magnetic, or one magnetic and one piece of metal plate. So, users are able to integrate any quantities of block LED lights 12 by their requirements and demands freely, and change the total electrical power consumption, shape, and size by modifying the quantities of block LED lights 12, to get the most suitable LED lights for real demands very easily. Furthermore, once the interior decoration is changed, these integrated LED lights can be disassembled directly in a very easy way. Even partial block LED lights 12 can be disassembled as temporarily light sources, and be assembled back after using them.

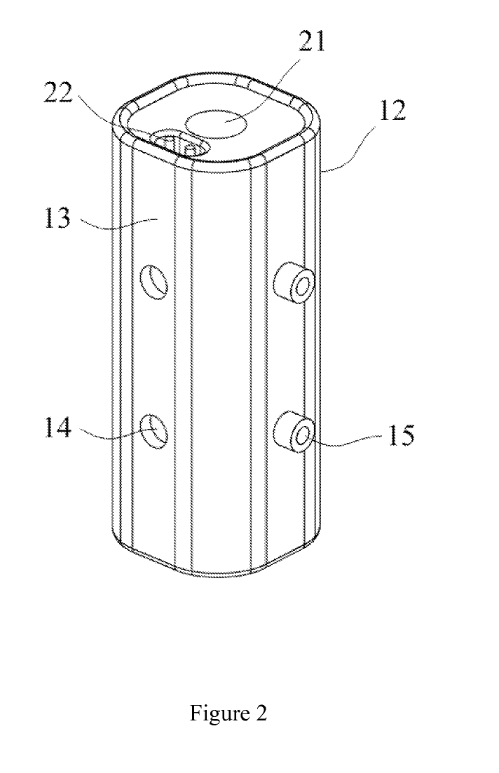

FIG. 2 shows the system's bottom architecture diagram of the executing embodiment to the present invention of the block LED light using one single case, in which contains one block LED light 12, case 13, embedded trough 14, embedded pillar 15, switch 21, and electrical power connection port 22. This block LED light 12 is able to use internal battery power supply, in which the batteries are implemented inside the case 13. At the bottom of case 13 containing an electrical power connection port 22, which is able to charge the batteries inside the case 13 via connecting the electrical power connection port 22 with electrical power source. At the bottom of case 13 also contains a switch 21, controlling the power of LED light module is on or off.

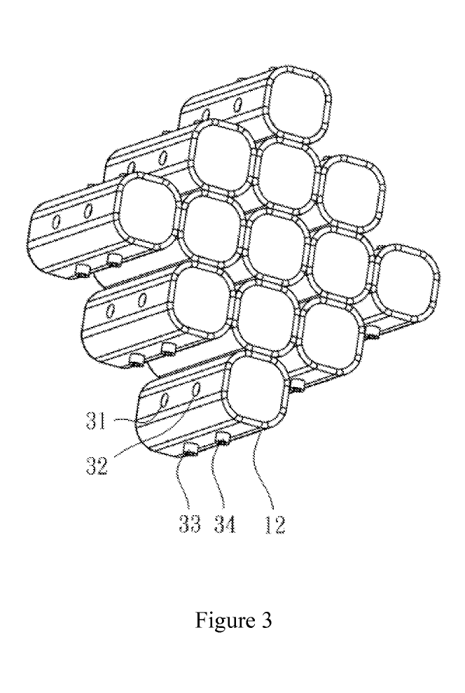

FIG. 3 shows the assembling architecture diagram of the executing embodiment to the present invention of multiple block LED lights using one single case, in which contains block LED light 12, embedded trough 31, 32, and embedded pillar 33, 34. Multiple block LED lights 12 are able to assemble together by integrating embedded trough 31, 32 with embedded pillar 33, 34. Every electrical plug of LED light module insides every block LED light 12 is able to extend to embedded trough 31, 32 and embedded pillar 33, 34, to make these above LED light modules have electrical series or parallel structure after assembling these multiple block LED lights 12, for example, extending all positive ports of LED light modules to the embedded trough 32 and embedded pillar 34 at the upper side, and extending all negative ports of LED light modules to the embedded trough 31 and embedded pillar 33 at the bottom side, then this will be an electrical parallel structure; extending all positive ports of LED light modules to the embedded trough 31 (or 32), and extending all negative ports of LED light modules to the embedded pillar 33 (or 34), then this will be an electrical series structure.

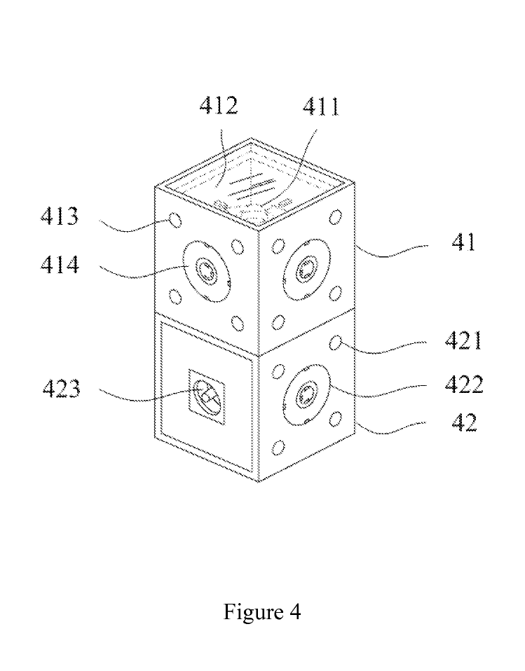

FIG. 4 shows the architecture diagram of the executing embodiment to the present invention of block LED light using grid power source, in which contains case 41, 42, LED light module 411, lamp shade 412, connection portion 413, 421, conductive component 414, 422, and power connection port 423. The electrical power portion of the LED light according to the present invention is also able to assemble together as block style. There is a containing space inside case 41, and the LED light module 411 is implemented in this containing space inside case 41. Lamp shade 412 is covered on the containing space of case 41, and also covers LED light module 411. There is an electrical power connection port 423 designed on the surface of case 32, to electrical connect with grid power source via one power cord.

There is at least one surface of case 41 containing connection portion 413 and conductive component 414, and the LED light module 411 is electrical connecting all conductive components 414 on the surface of case 41. There is at least one surface of case 42 containing corresponding connection portion 421 and conductive component 422, and the power connection port 423 is electrical connecting all conductive components 422 on the surface of case 42. Based on this design of connection portions 413, 421 and conductive components 414, 422, case 41 could be able to integrate with case 42 via the corresponding connection portions on the surface of case 41's bottom and on the surface of case 42's upper (this diagram does not figure out the connection portions on the surface of case 41's bottom and on the surface of case 42's upper). When the connection portions of case 41 and case 42 connect together, the conductive components of case 41's bottom will electrical connect with the conductive components of case 42's upper at the same time (this diagram does not figure out the conductive components on the surface of case 41's bottom the on the surface of case 42's upper), to make LED light module 411 be able to electrical connect with grid power source and be supplied by grid power.

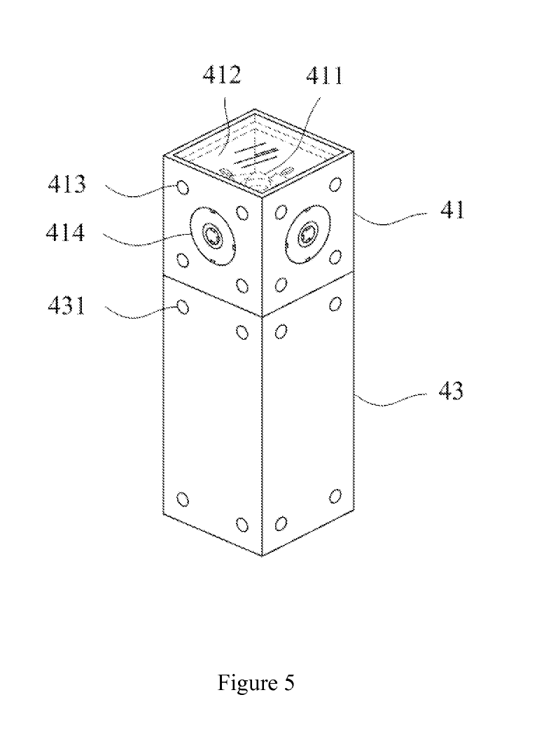

FIG. 5 shows the architecture diagram of the executing embodiment to the present invention of block LED light using battery power source, in which contains case 31, 32, LED light module 411, lamp shade 412, connection portion 413, 431, and conductive component 414. The present invention claims not only above LED light model which power supplies by grid power source, but also can be power supplied by other types of electrical power. Based on FIG. 5 of the present invention as an example of showing battery power supply model, there is designed an electrical power connection portion inside case 32, and designs a containing space to contain batteries, and electrical connects with the power connection portion inside the case 43. The upper surface of case 43 contains connection portion and conductive component that corresponds to the bottom surface of case 41 (this diagram does not figure out the corresponding connection portions and conductive components of case 41's bottom and case 43's upper), and the conductive component of case 43's upper surface electrical connects with internal electrical power connection portion, to electrical connect with the batteries inside case 43. Therefore, once case 41 connects with case 43 via the corresponding connection portions of case 41′ bottom and case 43's upper, the conductive component of case 41's bottom will be electrical connected with the conductive component of case 43′ upper, would make the LED light module 411 that implemented inside case 41 electrical connect with the batteries inside case 43, to supply electrical power to LED light module 411 by batteries.

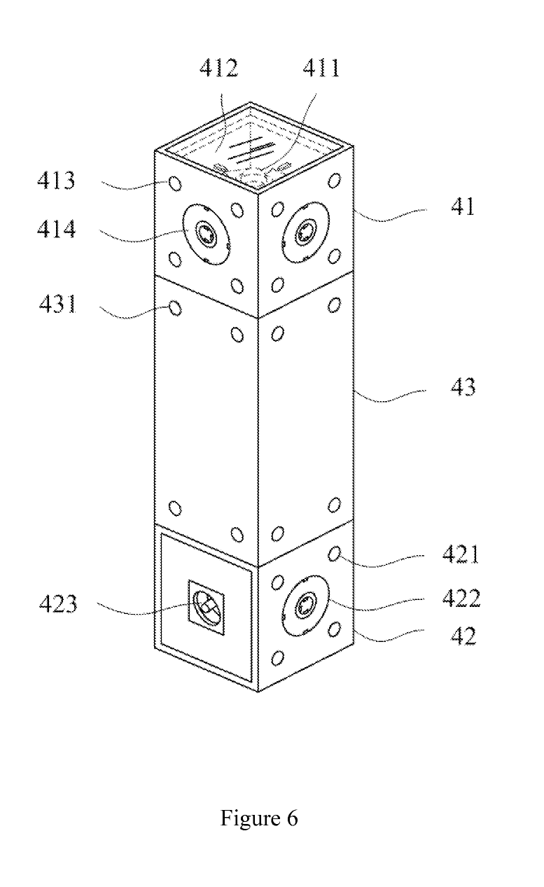

FIG. 6 shows the architecture diagram of the executing embodiment to the present invention of block LED light using chargeable battery power source, in which contains case 41, 42, 43, LED light module 411, lamp shade 412, connection portion 413, 421, 431, conductive component 414, 422, and electrical connection port 423. Case 42 can also be connected with the bottom of case 43, to make the batteries designed inside case 43 is able to electrical connect with the conductive component of case 42's upper side via the conductive component of case 43's bottom side, then electrical connects to grid power source through the electrical connection port 423, and to charge the batteries inside case 43.

In accordance with the executing embodiment to the present invention of block LED light, the conductive components 414, 422 designed on the surfaces of case 41, 42, 43 could be metal conductive plates. The connection portions 413, 42, 431 designed on the surfaces of case 41, 42, 43 could be corresponding embedded pillars and embedded troughs, to assemble these cases via this embedded mechanism. The connection portions on every single surface of case 41, 42, 43 could be all are embedded pillars, all are embedded troughs, or both, for example, the connection portion on the surface of case 42's upper side could be all are embedded pillars, and the connection portion on the surface of bottom side could be all are embedded troughs. Of course, connection portions 413, 421, 431 designed on the surfaces of case 41, 42, 43 can all are corresponding magnetic or combinations of magnetic and metal plates, and assembling these cases via magnetic attractive mechanism.

Therefore, in accordance with the executing embodiment to the present invention of block LED light, when users are at in-house environments, they can connect case 41 of LED light module 411 with case 42 which contains power connection port shown as FIG. 4, supplying power to LED light module 411 by grid electrical power source; when users are at out-door environments, the same case 41 of LED light module 411 could be connected with case 43 which contains batteries shown as FIG. 5, supplying power to LED light module 411 by batteries; once these above batteries need to be charged, users could connect to grid power source to supply electrical power to LED light module 411 and change batteries in parallel shown as FIG. 6.

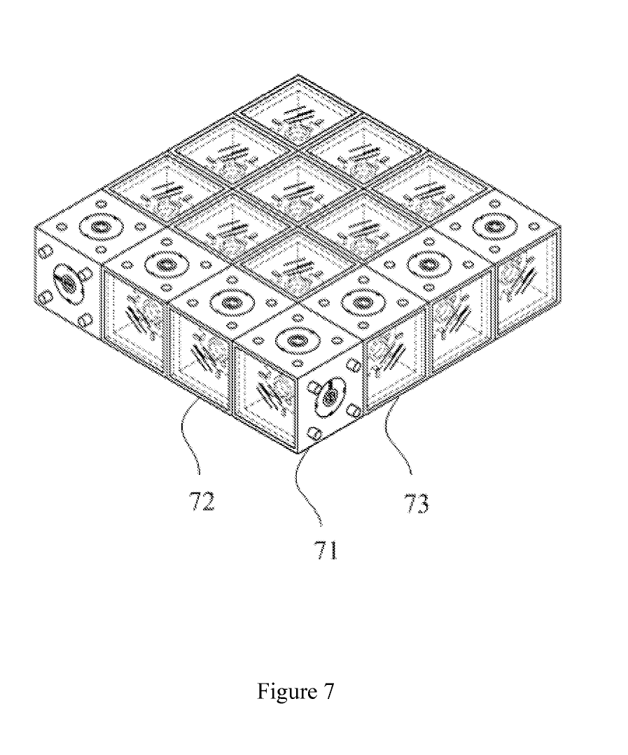

FIG. 7 shows the architecture diagram of the executing embodiment to the present invention of assembling multiple LED lights, which contains block LED light 71, 72, 73. The LED light 71 according to the present invention could be able to connect with other block LED lights 72, 73 with the same architecture via the connection portion designed on the surface of case, and after assembling these multiple block LED lights 71, 72, 73, these above block LED lights will be also electrical connected together because the conductive components on the surface or every case have electrical connected already, for example, as series structure or parallel structure, and can be power supplied by single one or multiple electrical power sources.

There are several advantages of the present invention:

1. In accordance with the executing embodiment to the present invention of block LED light, users are able to change the assembled shape and size by changing the assembled quantities and shape of block LED lights;

2. In accordance with the executing embodiment to the present invention of block LED light, users are able to get the most suitable LED lights by tuning the assembled quantities and total power consumption of block LED lights;

3. In accordance with the executing embodiment to the present invention of block LED light, block LED lights cab be disassembled and reassembled due to the modification of decoration; and partial block LED lights can be disassembled temporally for urgent light source requirement, which will be very convenient;

4. In accordance with the executing embodiment to the present invention of block LED light, users are able to use different electrical power types by their requirement demands;

5. In accordance with the executing embodiment to the present invention of block LED light, which is able to be used in every different environment, and even one single block LED light could meet different demands of usage purposes.

To sum up, in accordance with the executing embodiment to the present invention of block LED light, it is very easy and efficient to change the assembling quantities, shape, size, total power consumption, and electrical power types, is a very advance and useful solution. Even modifying the design that is described as the present invention, such as using different types of corresponding connection portions, using different shapes of cases on different types of LED light modules, or using other types of conductive components, once there is at least one pair of corresponding connection portions architecture designed on the case of LED light, and multiple of these above LED lights can be assembled as blocks, are all the claimed types that present invention covered.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A block LED light comprising:
a first case;
a LED light module in the first case;
a first connection portion on the surface of the first case;
a second connection portion on the surface of the first case.
wherein, the first connection portion is corresponding to the second connection portion, making another second block LED light with the same architecture is able to use its first connection portion assemble with the block LED light's second connection portion; and another third block LED light is able to use its second connection portion assemble with the block LED light's first connection portion; to assemble multiple block LED lights together by above mechanism.

2. The block LED light as claimed in claim 1, wherein the first connection portion contains at least one embedded pillar, and the second connection portions contains at least one embedded trough; the architecture of the above embedded pillar is corresponding to the above embedded trough; the block LED light uses its embedded pillar (embedded trough) to be assembled with another block LED lights' embedded trough (embedded pillar).

3. The block LED light as claimed in claim 1, wherein the first connection portion contains one first magnetic, and the second connection portion contains a second magnetic; the block LED light assembles with another block LED light by using its first magnetic to attract with the second magnetic on another block LED light.

4. The block LED light as claimed in claim 1, wherein the first connection portion contains one magnetic, and the second connection portion contains one piece of metal plate; the block LED light assembles with another block LED light by using its magnetic to attract with the metal plate on another block LED light.

5. The block LED light as claimed in claim 1, wherein the electrical power connection port of the LED light module extends to the first connection portion and the second connection portion, making multiple block LED lights be electrically connected together by series structure or parallel structure after assembling multiple block LED lights.

6. The block LED light as claimed in claim 1, wherein further comprises a first conductive component, a second case, a electrical power source connection port, a second conductive component, and a third connection portion; the first conductive component is designed on the surface of the first case, and electrically connects with the LED light module; the electrical power source connection port is designed in the second case and electrically connects with one electrical power source; the second conductive component and the third connection portion are designed on the surface of the second case, and the second conductive component electrically connects with the electrical power source connection port; the third connection portion of the second case is corresponding to the first connection portion of the first case, making the first case be able to assemble together with the second case via the connection of the first connection portion of the first case and the third connection portion of the second case, and making the first conductive component of the first case electrically connect with the second conductive component of the second case when the first connection portion of the first case connects to the third connection portion of the second case, and making the LED light module electrically connect to the electrical power source.

7. The block LED light as claimed in claim 6, wherein the first conductive component and the second conductive component are conductive plates.

8. The block LED light as claimed in claim 6, wherein the electrical power source connection portion is an electrical power connection port; and the electrical power source is a grid power.

9. The block LED light as claimed in claim 6, wherein a containing space is inside the second case, the electrical power source is a battery, which is designed in the containing space.

10. The block LED light as claimed in claim 6, wherein the first connection portion of the first case contains at least one embedded pillar, and the third connection portion of the second case contains at least one embedded trough; the architecture of the embedded pillar is corresponding to the embedded trough, and the first connection portion of the first case assemble with the third connection portion of the second case via integrating the embedded pillar and the embedded trough.

11. The block LED light as claimed in claim 6, wherein the first connection portion of the first case contains at least one embedded trough, and the third connection portion of the second case contains at least one embedded pillar; the architecture of the embedded trough is corresponding to the embedded pillar, and the first connection portion of the first case assembles with the third connection portion of the second case via integrating the embedded pillar and the embedded trough.

12. The block LED light as claimed in claim 6, wherein the first connection portion of the first case contains one first magnetic, the third connection portion of the second case contains one second magnetic; the first connection portion of the first case assembles with the third connection portion of the second case via attracting the first magnetic and the second magnetic.

13. The block LED light as claimed in claim 6, wherein the first connection portion of the first case contains one magnetic, the third connection portion of the second case contains one piece of metal plate; the first connection portion of the first case assembles with the third connection portion of the second case via attracting the magnetic and the piece of metal plate.

14. The block LED light as claimed in claim 6, wherein the first connection portion of the first case contains one piece of metal plate, the third connection portion of the second case contains one magnetic; the first connection portion of the first case assembles with the third connection portion of the second case via attracting the magnetic and the piece of metal plate.
